(19) United States
(12) Patent Application Publication
(10) Pub. No.: US 2007/0294679 A1
(43) Pub. Date: Dec. 20, 2007

(54) METHODS AND APPARATUS TO CALL NATIVE CODE FROM A MANAGED CODE APPLICATION

(76) Inventors: Konstantin Bobrovsky, Berdsk (RU); Vyacheslav Shakin, Novosibirsk (RU)

Correspondence Address: HANLEY, FLIGHT & ZIMMERMAN, LLC, 150 S. WACKER DRIVE, SUITE 2100, CHICAGO, IL, 60606, US

(21) Appl. No.: 11/460,328

(22) Filed: Jul. 27, 2006

(30) Foreign Application Priority Data
Jun. 20, 2006 (WO) PCTRU2006000321

(51) Int. Cl. G06F 9/45

(52) U.S. Cl. 717/146

(57) ABSTRACT

Methods and apparatus to call native code from a managed code application and to optimize such calls are disclosed. An example method includes converting a first bytecode to a first intermediate representation, receiving a second intermediate representation including a call to a native function and at least one annotation describing the native function, and replacing a portion of the first intermediate representation with a portion of the second intermediate representation to create a third intermediate representation.

### RELATED APPLICATIONS

This patent arises from a continuation of International Patent Application No. PCT/RU2006/000321, entitled “METHODS AND APPARATUS TO CALL NATIVE CODE FROM A MANAGED CODE APPLICATION” which was filed on Jun. 20, 2006. International Patent Application No. PCT/RU2006/000321 is hereby incorporated by reference in its entirety.

### FIELD OF THE DISCLOSURE

This disclosure relates generally to software applications and, more particularly, to managed software applications.

### BACKGROUND

The desire for increased software application portability (i.e., the ability to execute a given software application on a variety of platforms having different hardware, operating systems, etc.), as well as the need to reduce time to market for independent software vendors (ISVs), have resulted in increased development and usage of managed runtime environments (MRTEs) and virtual machines (VMs).

VMs are typically implemented to execute programs written in a dynamic programming language such as, for example, Java and C#. A software engine (e.g., a Java Virtual Machine (JVM) and Microsoft .NET Common Language Runtime (CLR), etc.), which is commonly referred to as a runtime environment, translates dynamic programming instructions (e.g., bytecode) of the managed application to target platform (i.e., the hardware and operating system(s) of the computer executing the dynamic program) instructions so that the dynamic program can be executed in a platform independent manner.

In particular, dynamic program language source code is compiled to dynamic program language instructions (e.g., bytecode). Dynamic program language instructions are not statically compiled and linked directly into machine code. Rather, dynamic program language instructions are compiled into an intermediate language (e.g., bytecode), which may be interpreted or subsequently compiled by a just-in-time (JIT) compiler into machine code that can be executed by the target processing system or platform. Typically, the JIT compiler is provided by a VM that is hosted by the operating system of a target processing platform such as, for example, a computer system. Thus, the VM and, in particular, the JIT compiler, translates platform independent program instructions (e.g., Java bytecode, Common Intermediate Language (CIL), etc.) into machine code (i.e., instructions that can be executed by an underlying target processing system or platform).

Native code consists of instructions that are compiled down to methods or instructions that are specific to the operating system and/or processor of a target platform. For example, the native code may be a C program that has been compiled to machine code. Because managed code may not be able to properly interface with all native applications, functions, libraries, or methods, calls to native applications, functions, libraries, or methods may be handled through an application programming interface (API), such as the Java Native Interface (JNI). JNI is a framework that allows code running in a VM to call and be called by native applications, functions, methods, and libraries written in other languages.

The JNI framework is conservative because it assumes that called native methods can do everything allowed by the JNI interface including object allocation and manipulation, exception triggering, etc. Thus, native methods are usually called via stubs arranging the necessary environment for all possible operations provided by JNI. The stubs introduce considerable performance overhead, which is especially noticeable when the called native methods are simple and fast. On the other hand, such simple and fast native methods often do not use a majority of the JNI functionality or do not use it at all.

Managed application bytecode comprises intermediate representations that are platform independent, but much less abstract and more compact than the human-readable format from which they are derived. The managed application bytecode is typically compiled by a just-in-time (JIT) compiler, resulting in machine code specific to a computer platform. As such, the managed application bytecode may be distributed to many target computers without regard to the variation of the target platforms because the JIT compiler manages the details associated with the platform variations.

Traditionally, managed application source code and bytecode have been high level representations that do not allow a user to perform low-level optimization of an application. Intermediate representation code at a level between bytecode and executable code generated by a JIT compiler comprises more fine grained operations to enable efficient code transformations. The usage of JIT intermediate representations for manual optimization of a managed application is described in U.S. patent application Ser. No. 11/395,832 filed on Mar. 31, 2006. Two example intermediate representations referenced in this disclosure are the high-level intermediate representation (HIR) and the low-level intermediate representation (LIR).

### BRIEF DESCRIPTION OF THE DRAWINGS

FIG. 1 is a block diagram of an example system for enabling calls to native code from code associated with a managed application.

FIG. 2 is a block diagram of a second example system for enabling calls to native code from code associated with a managed application.

FIG. 3A is representative of an example process to load an HIR source prior to compiling a managed application.

FIG. 3B is representative of an example process to compile a managed application including a call to a native method.

FIG. 3C is representative of an example process to compile a managed application including a call to a native method.

FIG. 4 is an example JAVA source code including three native methods.

FIG. 5 is two example native code functions written in C and conforming to JNI.

FIG. 6 is example HIR source code.

FIG. 7 is a block diagram of an example computer system capable of implementing the apparatus and methods disclosed herein.

### DETAILED DESCRIPTION

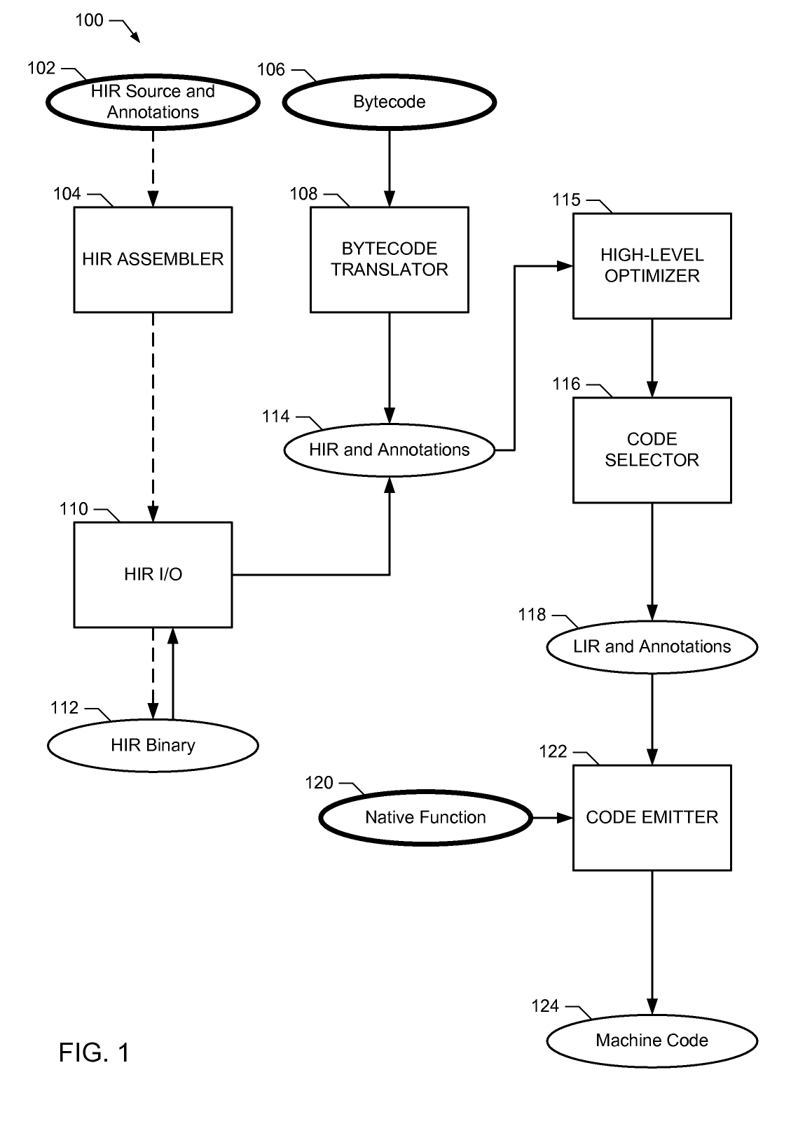

FIG. 1 is a block diagram of an example system 100 for enabling calls to native code from code associated with a managed application. The example methods and apparatus disclosed herein enable users to develop managed software applications that are capable of calling native functions. In general, the example methods and apparatus described herein utilize high-level intermediate representation (HIR) code to override calls to native functions in managed applications.

The example system 100 comprises computer instructions HIR source and annotations (HIRSA) 102, bytecode 106, HIR binary 112, HIR and annotations 114, low-level intermediate representation (LIR) and annotations 118, native function 120, and machine code 124. To perform the example methods described herein, the example system also includes an HIR assembler 104, a bytecode translator 108, an HIR input/output (I/O) 110, a high-level optimizer 115, a code selector 116, and a code emitter 122. In the example system 100, the computer instructions illustrated with darkened borders are provided as inputs to the system 100. For example, a user may author and/or generate the computer instructions illustrated with darkened borders. The dashed lines (e.g., the line between the HIRSA 102 and the HIR assembler 104) represent operations that are performed prior to runtime. The solid lines (e.g., the line between the bytecode 106 and the bytecode translator 108) represent operations that are performed at runtime via just-in-time (JIT) compilation.

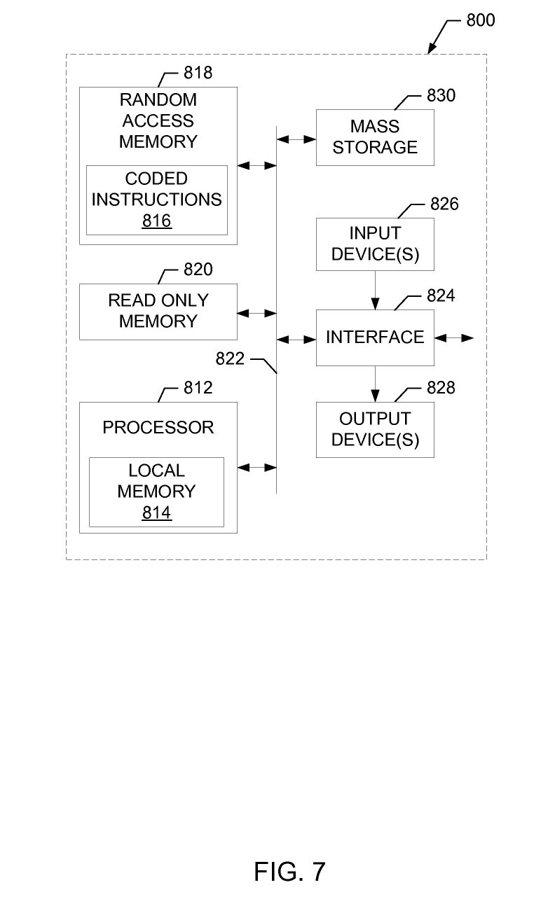

The example HIRSA 102 comprises HIR instructions that enable (e.g., instruct) a computer (e.g., computer 800 of FIG. 7) to call the native function 120. The HIRSA 102 includes instructions that enable the computer to pass parameters (e.g., variables, data, etc.) to the native function 120 and to receive returned values from the native function 120. The HIRSA 102 includes annotations that describe the types of data that the native function 120 can accept and the types of data that the native function 120 returns. In particular, the example HIRSA 102 includes instructions that enable the computer to convert parameters that are to be passed to the native function 120 from a first type to a second type.

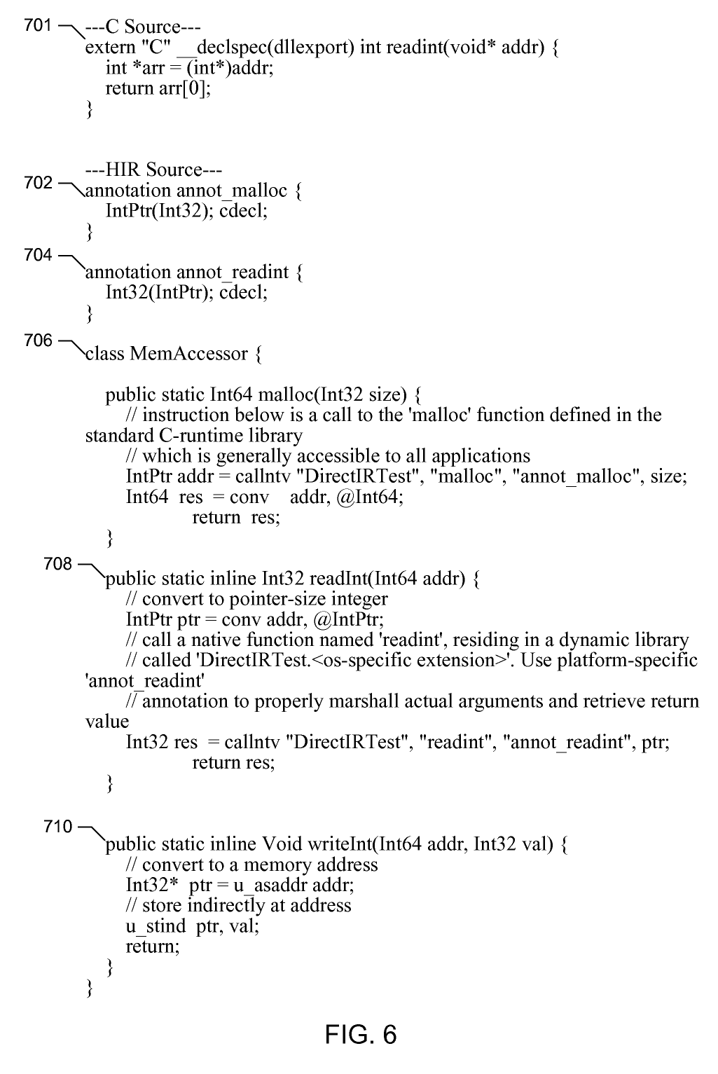

The example HIRSA 102 includes instructions that enable the computer to receive the annotations and call the native function. The example HIRSA 102 also includes instructions that enable the computer to return the result of the call to the native function 120 to the program or application that required the call to the native function 120. If the native function 120 is to operate on an array that is a part of the managed environment, then the HIRSA 102 will also include instructions to retrieve the memory location of the array's first element and pass the memory location of the array's first element to the native function 120. The HIRSA 102 also includes instructions to indicate that the memory location associated with the array is pinned or locked so that the garbage collection service of the managed environment does not move or remove the array. An example of the HIRSA 102 is illustrated in FIG. 6.

The HIR assembler 104 receives the HIRSA 102 and converts the HIRSA 102 into the HIR binary code 112. The HIR binary code 112 is transferred to memory via the HIR I/O 110. For example, the HIR assembler 104 may generate the HIR binary code 112 and store the HIR binary code 112 on an available memory or hard disk storage device (not shown in FIG. 1). The HIR I/O 110 retrieves the HIR binary code 112 from the memory or the hard disk storage device and transfers the HIR binary code 112 into active memory. As illustrated by the dashed lines, the example HIR assembler 104 generates the HIR binary code 112 prior to the execution of the managed application or program.

The bytecode 106, of the illustrated example, is Java bytecode output from a Java compiler. The bytecode 106 may alternatively be any type of managed application bytecode. For example, the bytecode 106 may be bytecode for a language associated with the CLR.

A compilation driver (not illustrated) may be provided to control the compilation process by invoking the illustrated components (bytecode translator 108, high-level optimizer 115, code selector 116, and code emitter 122). The compilation driver may serve two types of requests from the VM. The first request is for compilation of a method's bytecode. A compilation request is fulfilled by the compilation driver by pushing the bytecode into the compilation pipeline starting from the bytecode translator 108. The second request is for handling an HIR of a method. An HIR handling request is fulfilled by pushing the HIR into the compilation pipeline starting from the high-level optimizer 115 or code selector 116. The HIR is loaded from an HIR binary by the class loading subsystem. Upon class loading, the VM determines which native methods of the loaded class are overridden in the HIR binary and loads the overriding HIR of the methods from the binary. The VM also arranges the data of internal methods so that upon invocation of each overridden method, the HIR of the overridden method will be passed to the JIT compiler for generating executable code from it.

The bytecode translator 108 receives the bytecode 106 and translates the bytecode 106 to HIR in-memory format. For example, the bytecode 106 may be translated and included in the HIR and annotations 114 when the managed application or program is executed.

The HIR and annotations 114 is representative of the collection of HIR binary code including annotations that are available for use in the managed application or program.

The high-level optimizer 115, among other optimizations, analyzes the HIR of the compiled method to determine if any of the native methods called from the compiled method have been overridden by methods in the HIR binary 112 and inlines the overriding methods into the HIR of the method being compiled. For example, if the translated HIR includes a call to a native method and the HIR binary contains an overriding method for the called method, the high-level optimizer 115 replaces the call with the overriding method.

The code selector 116 translates the modified HIR and annotations 114 received from the high-level optimizer 115 into the LIR and annotations 118. The LIR and annotations 118 are low-level intermediate representation instructions corresponding to the HIR and annotations 114 translated by the code selector 116. The LIR and annotations 118 are transmitted to the code emitter 122.

The native function 120 is any program, function, or method compiled to native code. For example, the native function 120 may be compiled from C language source code. The native function 120 may alternatively be compiled from any other native code language such as, for example, C++, assembly, etc.

The code emitter 122 receives the LIR and annotations 118 and compiles them into machine code instructions 124 that may be executed by a processor. According to the illustrated example, the machine code instructions 124 are machine-dependent. In other words, the machine code instructions 124 are designed to be executed on a system with the same architecture as the machine that generated them. The code emitter 122 also links the machine code instructions with the native function 120. For example, the code emitter 122 may store an address associated with the native function 120 in memory that is accessed by the machine code 124 to call a native method.

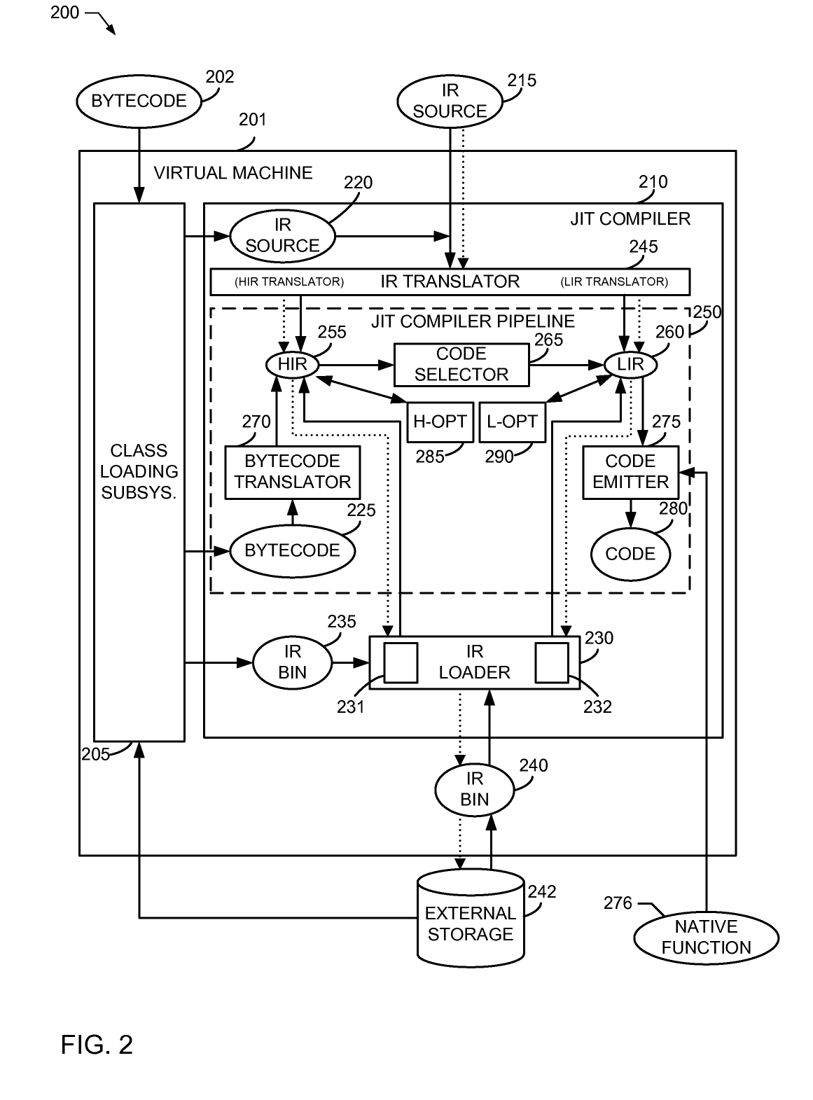

FIG. 2 is a block diagram of a second example system 200 for enabling calls to native code from code associated with a managed application. The example system 200 comprises an example VM 201, which includes a class loading subsystem 205 that, among other functions, locates and imports binary data for classes subsequently forwarded to a JIT compiler 210. FIG. 2 is described below with operations shown as rectangles and data shown as ovals.

As discussed in further detail below, if a user has created optimized HIR and/or LIR, then the class loading subsystem 205 finds such stored binaries and forwards them to the JIT compiler 210 instead of bytecode 202 and 215. For example, if the user has created HIR code to access a native method, the HIR code will replace a call to the native method in the HIRs of all methods whose bytecode contain such a call. The JIT compiler 210 may receive IR source code 215 generated by a user (e.g., HIR source code, LIR source code), IR source code 220 from the class loading subsystem 205, bytecode 225, and IR binaries 235, 240 from the class loading subsystem 205 or directly from a library in an external storage 242 as discussed in further detail below. Users may generate HIR and LIR source code as, for example, a text file. The example JIT compiler 210 also includes an IR translator 245, an IR loader 230, and a JIT compiler pipeline 250. The JIT compiler pipeline 250 includes in-memory HIR 255, in-memory LIR 260, a code selector 265, a bytecode translator 270, a code emitter 275, and generated code 280. Additionally, the JIT compiler pipeline 250 includes a high-level optimizer (H-OPT) 285 and a low-level optimizer (L-OPT) 290.

The example VM 201 may operate in either an ahead-of-time mode or a just-in-time mode. The ahead-of-time mode allows the user to translate hand-tuned HIR and/or the LIR source code 215 to a binary format for future use. For example, dotted arrows indicate various VM 201 components employed during the ahead-of-time mode, and solid arrows indicate components that may be used during the just-in-time (or runtime) mode. In particular, the IR source code 215 is provided to the IR translator 245 to translate textual representations of an HIR and/or LIR program to the in-memory HIR 255 representations and/or the in-memory LIR 260 representations (e.g., data structures). The in-memory format is provided to the IR loader 230, which contains an HIR serializer/deserializer (SERDES) 231 to convert the HIR in-memory representations into a binary format and to convert the HIR binary format to an HIR in-memory representation. Similarly, the IR loader 230 contains an LIR SERDES 232 to convert the LIR in-memory representations into a binary format and to convert the LIR binary format to an LIR in-memory representation. The IR binaries 240 resulting from the HIR and/or LIR serializers 231 and 232 are stored in the external storage 242 in, for example, user-defined attributes of class files or external libraries in proprietary formats.

During the run-time mode, IR binaries of the external memory are embedded into the JIT compiler pipeline 250. In particular, the class loading subsystem 205 determines if an IR binary of the method is represented in the external storage 242. If so, rather than compiling the bytecode 202, 225 with the bytecode translator 270, the IR binaries 240 are retrieved from the class loading subsystem 205 or directly from a library in the external storage 242 and deserialized into IR in-memory representations 255, 260 by the deserializers of the IR loader 230. HIR in-memory representations of the JIT compiler pipeline 250 are translated to the in-memory LIR 260 by the code selector 265 during run-time. The code emitter 275 produces code 280 from the IR in-memory representations that are suitable for a target machine. The code emitter 275 also links the code 280 with the native function 276. For example, the code emitter 275 may store an address associated with the native function 276 in memory that is accessed by the code 280 to call a native method.

To help reduce the traditional bottleneck that occurs during the transition from managed code to native code (e.g., using the JNI), users may develop HIR and/or LIR as an alternative to JNI stubs that traditionally allow safe operation of managed entities. Rather than reliance upon the JNI for management of the formal parameters of the native call, proper exception handling (should it occur in the native method), garbage collector safepoints, and/or other tasks associated with managed-to-native code transition (which may depend on a particular JNI implementation), the user is provided an opportunity to develop HIR/LIR to handle such calls in any desired manner.

Although the foregoing discloses example methods and apparatus including, among other components, firmware and/or software executed on hardware, it should be noted that such methods and apparatus are merely illustrative and should not be considered as limiting. For example, it is contemplated that any or all of these hardware and software components could be embodied exclusively in dedicated hardware, exclusively in software, exclusively in firmware, or in some combination of hardware, firmware and/or software. Accordingly, while the following describes example methods and apparatus, persons of ordinary skill in the art will readily appreciate that the examples are not the only way to implement such systems.

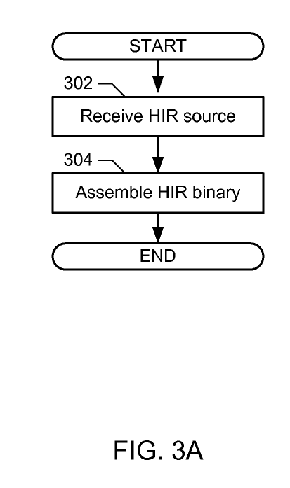

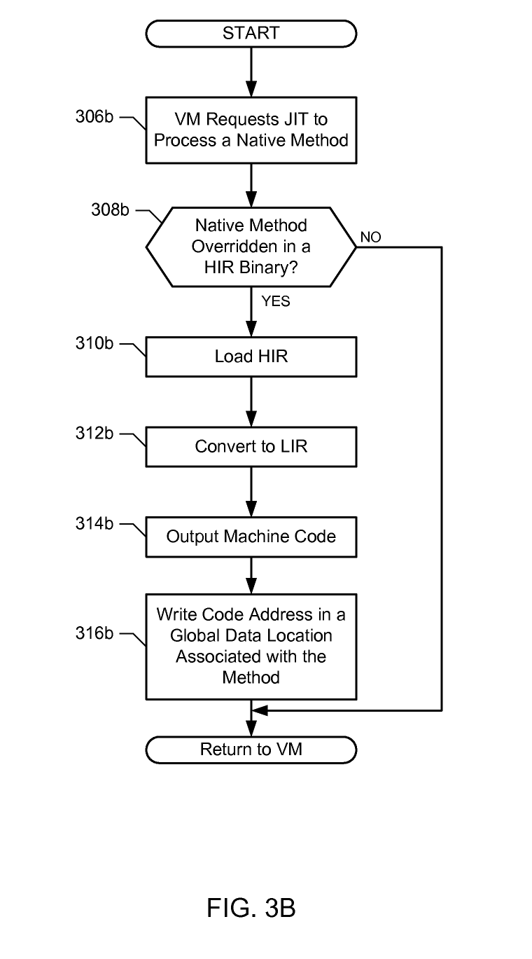

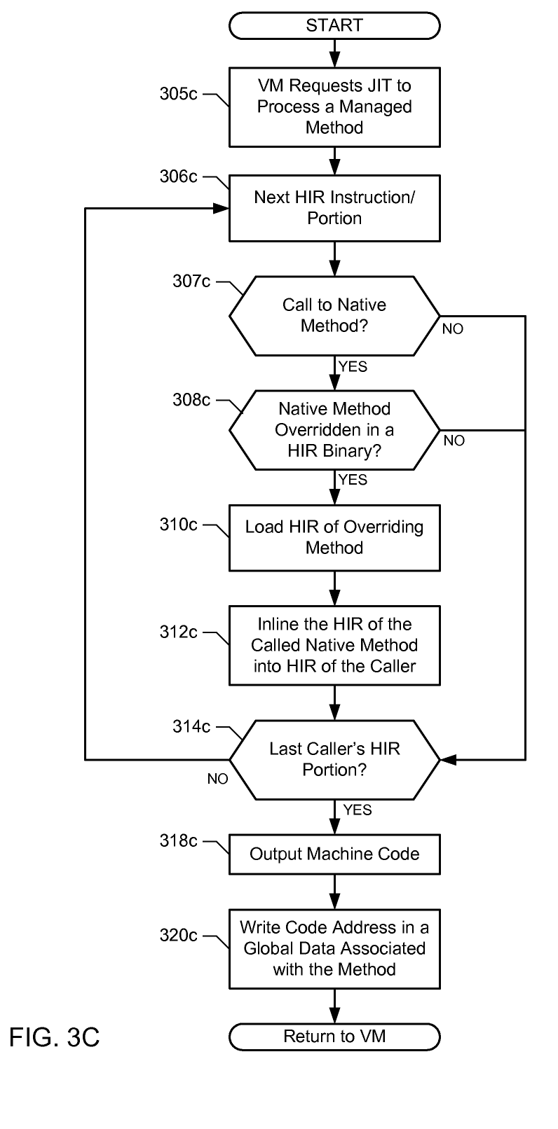

Flowcharts representative of example processes for implementing the example system 100 of FIG. 1 and/or the example system 200 of FIG. 2 are shown in FIGS. 3A, 3B, and 3C. In the example processes, the machine readable instructions comprise programs for execution by a processor such as the processor 812 shown in the example computer 800 discussed below in connection with FIG. 7. The programs may be embodied in software stored on a tangible medium such as a CD-ROM, a floppy disk, a hard drive, a digital versatile disk (DVD), or a memory associated with the processor 812. However, persons of ordinary skill in the art will readily appreciate that the entire program and/or parts thereof could alternatively be executed by a device other than the processor 812 and/or embodied in firmware or dedicated hardware in a well-known manner. For example, any or all of the HIR assembler 104, the bytecode translator 108, the high-level optimizer 115, the code selector 116, the code emitter 122, the class loading subsystem 205, and the JIT compiler 210 could be implemented by software, hardware, and/or firmware. Further, although the example programs are described with reference to the flowcharts illustrated in FIGS. 3A, 3B, and 3C, persons of ordinary skill in the art will readily appreciate that many other methods of implementing the example system 100 and/or the example system 200 may alternatively be used. For example, the order of execution of the blocks may be changed, and/or some of the blocks described may be changed, eliminated, or combined.

FIG. 3A is representative of an example process to load an HIR source prior to compiling a managed application. For ease of discussion, the execution of the operations depicted in FIG. 3A will be described with respect to system 100 of FIG. 1. However, persons of ordinary skill in the art will recognize that the example system 200 of FIG. 2 or any other system may be used instead.

The execution of the example process of FIG. 3A begins when the HIR assembler 104 of FIG. 1 receives the HIRSA 102 from a user (block 302). The HIRSA 102 may be manually created by the user or may be created using automatic code generation software. After receiving the HIRSA 102, the HIR assembler 104 converts the HIRSA 102 into the HIR binary 112 (block 304). As illustrated in FIG. 1, the HIR binary 112 may be stored in memory using the HIR I/O 110.

In the illustrated example, after creation of the HIR binary 112, the HIR binary 112 is stored and the system 100 waits for runtime; a portion of which is illustrated in FIGS. 3B and 3C. However, alternatively, blocks 302 and 304 may be performed at the time the managed application is compiled and, thus, the execution of processes illustrated in FIGS. 3B and 3C may immediately or almost immediately follow the execution of blocks 302 and 304.

FIG. 3B is representative of an example process to compile a managed application including a call to a native method. A virtual machine can use this process to handle any native method regardless of inlining decisions. For ease of discussion, the execution of the operations depicted in FIG. 3A will be described with respect to system 100 of FIG. 1. However, persons of ordinary skill in the art will recognize that the example system 200 of FIG. 2 or any other system may be used instead.

The execution of the example process begins when a VM calls a JIT compiler to process the native method (block 306b). Depending on the VM design this can happen when the native method is called for the first time or when VM loads a class containing the native method. In any case, the VM requests the JIT compiler to check whether the native method is overridden in HIR binary.

When requested to process a native method, the JIT compiler determines if the native method is overridden in the HIR binary (block 308b). If the method is not overridden, control returns to the virtual machine and all invocations of the native method will result in execution of the original native method. If the method is overridden in the HIR binary, the HIR version of the method is loaded and advanced further to the JIT compiler pipeline and optimized by the high-level optimizer 115 (block 310b). The HIR is then translated to LIR by the code selector 116 (block 312b). Then, the LIR is translated to machine code by the code emitter 122 (block 314b). The code emitter 122 writes or stores the address of the generated machine code in a global data location associated with the native method (block 316b) so that all invocations to the native method will result in execution of the version compiled by the JIT compiler from the HIR binary. After the machine code has been output and the code address has been written to the global data location, control returns to the virtual machine to continue executing the managed application.

FIG. 3C is representative of an example process to compile a managed application including a call to a native method that may be performed as an alternative or an addition to the example process illustrated in FIG. 3B. This process is implemented in a JIT compiler to inline native methods overridden in a HIR binary. For ease of discussion, the execution of the operations depicted in FIG. 3C will be described with respect to system 200 of FIG. 2.

The execution of the example process begins when a virtual machine handling the managed application requests the JIT compiler to produce the machine code from the bytecode (block 305c). For example, the virtual machine can be designed to call the JIT compiler upon first execution of a managed method.

The bytecode translator 270 translates the bytecode into HIR in-memory representation 255 which is then advanced to the high-level optimizer H-OPT 285. The H-OPT 285 analyzes the next instruction of the HIR in-memory representation 255 (e.g., the first instruction if no instructions have yet been analyzed) (block 306c). The H-OPT 285 determines if the instruction includes a call to a native method (block 307c). If the instruction does not include a call to a native method, control proceeds to block 314c, which will be described in detail below.

If the H-OPT 285 determines that the instruction does include a call to a native method, the H-OPT 285 determines if the native method is overridden in the HIR binary (block 308c). If the H-OPT 285 determines that the native method is not overridden in the HIR binary, control proceeds to block 314c, which will be described in detail below. If the H-OPT 285 determines that the native method is overridden in the HIR binary, H-OPT 285 loads the HIR binary (block 310c). For example, H-OPT 285 may load the HIR binary from a memory, a disk storage, etc.

After loading the overriding HIR instructions in the HIR binary, H-OPT 285 replaces the call to the native method with the overriding HIR instructions from the HIR binary (block 312c). For example, the HIR translated from the bytecode 225 may include a call to a native method wherein the native method is overridden by the HIR binary 240. H-OPT 285 will replace the call to the native method with the HIR instructions in the HIR binary 240. This inlining process can be done recursively for invocation instructions in the HIR inlined from the HIR binary.

After the inlining process is finished (exit from the loop controlled by the block 314c) the resulting HIR in-memory representation 255 is advanced for further transformation in the JIT compiler pipeline (not shown on FIG. 3C for clarity). Finally, the code emitter 275 outputs machine code (block 318c) and writes or stores the address of the generated machine code in a global data location associated with the compiled method (block 320c). The JIT compilation process completes as usual including other supporting operations not shown on FIG. 3C.

Persons of ordinary skill in the art will appreciate that processes similar to those described on FIG. 3B and FIG. 3C may be implemented with LIR and other intermediate representations in a JIT compiler. For clarity, this disclosure discusses only the processes using HIR.

Persons of ordinary skill in the art will recognize that all HIR may not be processed prior to generating the machine code. For example, a first part of an application may be converted to machine code and executed. At a time when the first part of the application references a second part of the application, the second part of the application is converted to machine code so that it may be executed. In other words, the second part of the application is compiled just-in-time for execution.

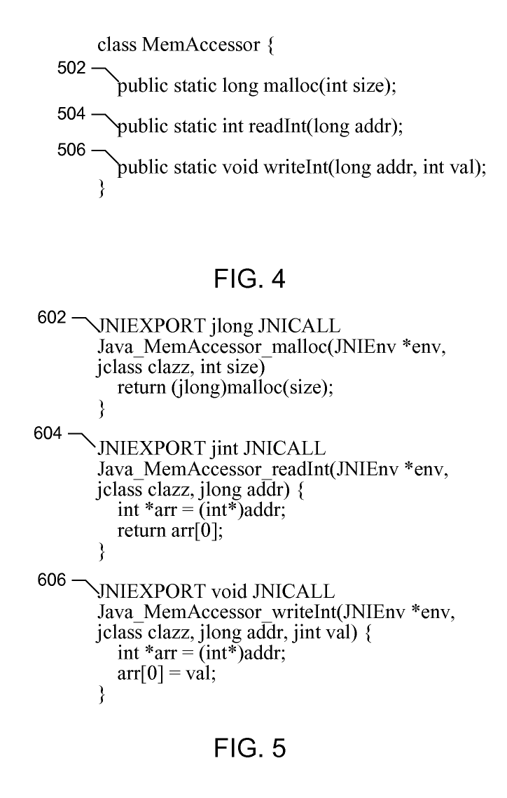

FIGS. 4-6 are sample instructions that may be used with the example system 100 and/or the example system 200. FIG. 4 is JAVA class with three native methods. FIG. 5 is three example native code functions written in C language, which follow the standard JNI-based manner of using native code from Java applications. FIG. 6 is example HIR source code and example C source code. Together, the HIR and C source code examples of FIG. 6 illustrate the example methods of calling native code from Java applications as described herein.

The JAVA source code in FIG. 4 includes three native methods (502, 504, and 506) that are overridden by the HIR source code illustrated in FIG. 6. The native code in FIG. 5 includes three functions (602 to 606) that are traditional implementations of the native methods.

The HIR source code of FIG. 6 includes a first annotation 702, a second annotation 704, a first overriding method 706, a second overriding method 708, and a third overriding method 710. The C source code of FIG. 6 includes the native function 701 called by the HIR source code illustrated in FIG. 6.

The first annotation 702 is associated with the standard C-runtime function “malloc” used to allocate memory. The instruction ‘Int32(IntPtr)’ instructs the machine that the “malloc” function returns void* and accepts an integer as a parameter. The instruction ‘cdecl’ instructs the machine that the native function is compiled with the cdecl IA32 calling convention. The second annotation 704 is associated with the native function 701 of FIG. 6. The instruction ‘Int32 (IntPtr)’ instructs the machine that the native function 701 returns a 32-bit integer and accepts a pointer-size integer as a parameter. The instruction ‘cdecl’ instructs the machine that the native function is compiled with the cdecl IA32 calling convention.

The first method 706 overrides the method 502 of FIG. 4. The method declaration indicates that the method accepts a 32-bit integer and returns a 64-bit integer. The instruction ‘IntPtr addr=callntv “malloc”, “annot_malloc”, size;’ calls the standard C-runtime “malloc” function using the annotation 702 and stores the result as a pointer in a variable called ‘addr’. This instruction instructs the machine executing the instructions to directly call the native function. The instruction ‘Int64 res=conv addr, @Int64;’ converts the 32-bit integer stored in addr to a 64-bit integer and stores the value in ‘res’. The instruction ‘return res;’ returns the value stored in ‘res’ to the method that called the method 706 via method 502. The first method 706 is an example implementation that shows an efficient call to a pre-defined native function.

The second method 708 overrides the method 504 of FIG. 4. The method declaration indicates that the method accepts a 64-bit integer and returns a 32-bit integer. The instruction ‘IntPtr ptr=conv addr, @IntPtr;’ instructs the machine to convert the 64-bit integer stored in ‘addr’ to a pointer sized integer and store the value in ‘ptr’. The instruction ‘Int32 res=callntv “DirectIRTest”, “readint” “annot_readint”, ptr;’ instructs the machine to call the native function 701 using the annotation 704 passing the value stored in ‘ptr’ and store the result as a 32-bit integer in ‘res’. The instruction ‘return res;’ returns the value stored in ‘res’ to the method that called the method 708 via method 504. The second method 708 is an example implementation that uses IR to efficiently call a user-defined native function.

The third method 710 overrides the method 506 of FIG. 4. The method declaration indicates that the method accepts a 64-bit integer and a 32-bit integer and returns no values. The instruction ‘Int32* ptr=u_asaddr addr;’ converts the contents of ‘addr’ passed to the method into a 32-bit integer pointer that is a raw address in ‘ptr’. The instruction ‘u_stind ptr, val;’ indirectly stores the contents of ‘val’ passed to the method in the address referenced by ‘ptr’. The instruction ‘return;’ ends the execution of the third method 710 without returning any values. The third method 710 is an example implementation that uses IR to inline the native function in a managed application.

Persons of ordinary skill in the art will recognize that the code shown in FIGS. 4-6 are provided as examples and that many variations and implementations are possible.

FIG. 7 is a block diagram of an example computer 800 capable of executing the machine readable instructions represented by FIGS. 3A to 3C and 4 to 6 to implement the apparatus and/or methods disclosed herein.

The system 800 of the instant example includes a processor 812 such as a general purpose programmable processor. The processor 812 includes a local memory 814, and executes coded instructions 816 present in random access memory 818 and/or in another memory device. The processor 812 may execute, among other things, the machine readable instructions illustrated in FIGS. 3A to 3C and 4 to 6. The processor 812 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 812 is in communication with a main memory including a volatile memory 818 and a non-volatile memory 820 via a bus 822. The volatile memory 818 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 820 may be implemented by flash memory and/or any other desired type of memory device. Access to the main memory 818, 820 is typically controlled by a memory controller (not shown) in a conventional manner.

The computer 800 also includes a conventional interface circuit 824. The interface circuit 824 may be implemented by any type of well known interface standard, such as an Ethernet interface, a universal serial bus (USB), and/or a third generation input/output (3GIO) interface.

One or more input devices 826 are connected to the interface circuit 824. The input device(s) 826 permit a user to enter data and commands into the processor 812. The input device(s) can be implemented by, for example, a keyboard, a mouse, a touchscreen, a track-pad, a trackball, isopoint and/or a voice recognition system.

One or more output devices 828 are also connected to the interface circuit 824. The output devices 828 can be implemented, for example, by display devices (e.g., a liquid crystal display, a cathode ray tube display (CRT), a printer and/or speakers). The interface circuit 824, thus, typically includes a graphics driver card.

The interface circuit 824 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 800 also includes one or more mass storage devices 830 for storing software and data. Examples of such mass storage devices 830 include floppy disk drives, hard drive disks, compact disk drives and digital versatile disk (DVD) drives.

As an alternative to implementing the methods and/or apparatus described herein in a system such as the device of FIG. 7, the methods and/or apparatus described herein may alternatively be embedded in a structure such as processor and/or an ASIC (application specific integrated circuit).

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method comprising:
converting a first bytecode to a first intermediate representation;
receiving a second intermediate representation including a call to a native function and at least one annotation describing the native function; and
replacing a portion of the first intermediate representation with a portion of the second intermediate representation to create a third intermediate representation.

2. A method as defined in claim 1, wherein replacing the portion of the first intermediate representation comprises inlining the second intermediate representation in the first intermediate representation.

3. A method as defined in claim 1, wherein the portion of the first intermediate representation comprises the entire first intermediate representation.

4. A method as defined in claim 1, wherein the method is performed by a just-in-time compiler.

5. A method as defined in claim 1, wherein the first bytecode is at least one of compiled JAVA code or compiled code from a language associated with a common language runtime (CLR).

6. A method as defined in claim 1, wherein the portion of the first intermediate representation includes a call to the native function.

7. A method as defined in claim 6, wherein the call uses a JAVA native interface.

8. A method as defined in claim 1, further comprising determining if the portion of the first bytecode includes a call to the native function.

9. A method as defined in claim 8, wherein replacing the portion of the first intermediate representation is performed based on the determination.

10. A method as defined in claim 1, further comprising receiving a second bytecode that references the first bytecode.

11. An article of manufacture storing machine readable instructions which, when executed, cause a machine to:
convert a first bytecode to a first intermediate representation;
receive a second intermediate representation, the second intermediate representation including a call to a native function and at least one annotation describing the native function; and
replace a portion of the first intermediate representation with the second intermediate representation to create a third intermediate representation.

12. An article of manufacture as defined in claim 11, wherein replacing the portion of the first intermediate representation comprises inlining the second intermediate representation in the first intermediate representation.

13. An article of manufacture as defined in claim 11, wherein the portion of the first intermediate representation comprises the entire first intermediate representation.

14. An article of manufacture as defined in claim 11, wherein the machine readable instructions implement a just-in-time compiler.

15. An article of manufacture as defined in claim 11, wherein the first bytecode is at least one of compiled JAVA code or compiled code from a language associated with a common language runtime (CLR).

16. An article of manufacture as defined in claim 11, wherein the portion of the first intermediate representation includes a call to the native function.

17. An article of manufacture as defined in claim 16, wherein the call uses a JAVA native interface.

18. An article of manufacture as defined in claim 11, wherein the machine readable instructions further cause the machine to determine if the portion of the first intermediate representation includes a call to the native function.

19. An article of manufacture as defined in claim 18, wherein replacing the portion of the first intermediate representation is performed based on the determination.

20. An article of manufacture as defined in claim 11, wherein the machine readable instructions further cause the machine to receive a second bytecode that references the first bytecode.

21. An apparatus comprising:
an intermediate representation (IR) assembler to receive IR code;
a memory to store an IR binary including annotations associated with a native function received from an IR loader;
at least one of a serializer or a deserializer to convert the IR binary to an in-memory IR; and
an IR optimizer to replace at least one invocation instruction with at least one instruction from the in-memory IR.

22. An apparatus as defined in claim 21, further comprising a bytecode translator to receive a first bytecode including the at least one invocation instruction and to translate the first bytecode to IR.

23. An apparatus as defined in claim 21, wherein replacing the at least one invocation instruction with at least one instruction from the in-memory IR comprises inlining the at least one instruction from the in-memory IR.

24. An apparatus as defined in claim 21, further comprising a code emitter to convert the at least one instruction from the in-memory IR to machine code.

25. An apparatus as defined in claim 21, further comprising a code selector to convert the at least one instruction from the in-memory IR to a low-level intermediate representation (LIR).

26. An apparatus as defined in claim 21, wherein the IR code is high-level intermediate representation (HIR).

27. An apparatus as defined in claim 21, wherein the at least one invocation instruction is at least one of compiled JAVA code or compiled code from a language associated with a common language runtime (CLR).

28. An apparatus as defined in claim 21, wherein the at least one invocation instruction includes a call to the native function.

29. An apparatus as defined in claim 28, wherein the invocation instruction uses the JAVA native interface.
